(19) United States
(12) Patent Application Publication
(10) Pub. No.: US 2012/0123655 A1
(43) Pub. Date: May 17, 2012

(54) VEHICLE OPERATION DEVICE

(75) Inventor: Fumito Kurata, Shizuoka (JP)

(73) Assignee: TOYOTA JIDOSHA KABUSHIKI KAISHA, Toyota-shi, Aichi (JP)

(21) Appl. No.: 13/386,994

(22) PCT Filed: Jul. 31, 2009
(86) PCT No.: PCT/JP2009/063684

§ 371 Date: Jan. 25, 2012

(51) Int. Cl. G06F 7/00

(52) U.S. Cl. 701/70; 701/1

(57) ABSTRACT

Disclosed is a vehicle operation device capable of reducing a sense of discomfort imposed on a driver when the driver carries out a driving operation and suppressing a vehicle behavior not intended by the driver. A vehicle operation ECU determines control amounts of a throttle actuator and a brake actuator in accordance with operation amounts of an accelerator pedal and a brake pedal. When a steering is being operated, a dead zone for a control amount according to an operation of a pedal is adjusted. For example, when the steering is turned to the left, the dead zone of the accelerator pedal disposed on the right side, that is, on a turning outer wheel side of the vehicle is increased.

### TECHNICAL FIELD

The present invention relates to a vehicle operation device.

### BACKGROUND ART

When driving a vehicle, a driver operates an accelerator pedal or a brake pedal. When the driver operates a pedal, acceleration/deceleration control of the vehicle is performed in accordance with the operation amount of the pedal. A technique is known in which the relationship between the pedal position or pedal reactive force and the driving force or braking force of the vehicle is set. As this technique, in the related art, a technique has been disclosed in which, even when the state of the vehicle is changed, the pedal reactive force or vehicle output is not changed (for example, see Patent Literature 1). In this technique, while the pedal reactive force or vehicle output is not changed, the inclination of the pedal reactive force or the like is changed. For this reason, it is possible to change the pedal position or vehicle output in accordance with parameters based on operation information, vehicle information, and environmental information without giving the driver a sense of discomfort.

### CITATION LIST

### Patent Literature

[Patent Literature 1] Japanese Unexamined Patent Application Publication No. 2006-281809

### SUMMARY OF INVENTION

### Technical Problem

When a driver carries out a driving operation, such as a pedal operation, the driver may carry out an unconscious driving operation. At this time, in the technique described in Patent Literature 1, the inclination of the pedal reactive force is changed without changing the pedal reactive force or vehicle output. For this reason, the vehicle may show a behavior which the driver is not conscious, causing a problem in that it is difficult to reduce a sense of discomfort imposed on the driver.

Accordingly, an object of the invention is to provide a vehicle operation device capable of reducing a sense of discomfort imposed on a driver when the driver carries out a driving operation and suppressing a vehicle behavior not intended by the driver.

### Solution to Problem

The invention having achieved the object provides a vehicle operation device. The vehicle operation device includes a vehicle operation member which is operable by a driver, and a vehicle controller which performs control based on an operation of the vehicle operation member. A dead zone where a control amount is suppressed is set in a control range by the vehicle controller, and the range of the dead zone is adjusted on the basis of at least one of a vehicle state in a vehicle and the traveling environment of a traveling path along which the vehicle travels.

The vehicle may show a behavior which the driver is not conscious depending on the vehicle state in the vehicle and the traveling environment of the traveling path along which the vehicle travels. From this viewpoint, in the vehicle operation device according to the invention, the dead zone where a control amount is suppressed is set in the control range by the vehicle controller, and the range of the dead zone is adjusted on the basis of at least one of the vehicle state and the traveling environment. Therefore, it is possible to reduce a sense of discomfort imposed on the driver when the driver carries out a driving operation and to suppress a vehicle behavior not intended by the driver.

A control amount by the vehicle controller may be shifted in accordance with an adjustment amount of the dead zone.

In this way, the control amount by the vehicle controller is shifted in accordance with the adjustment amount of the dead zone, thereby maintaining the control amount according to the adjustment amount of the vehicle operation member. Therefore, it is possible to perform control in which an intention of the driver to operate the vehicle operation member is suitably reflected.

The vehicle operation member may be at least one of an accelerator pedal and a brake pedal.

When the accelerator pedal or the brake pedal is operated, a behavior which the driver is not conscious is conspicuous. Therefore, when the vehicle operation member is the accelerator pedal or the brake pedal, it is possible to more suitably achieve the reduction of a sense of discomfort imposed on the driver and to suppress a vehicle behavior not intended by the driver.

The vehicle state may be a turning state of the vehicle based on an operation of a vehicle turning member by the driver, and when there is the turning state based on the operation of the vehicle turning member by the driver, the width of the dead zone may be adjusted to be larger than when there is no turning state based on the operation of the vehicle turning member by the driver.

When there is the turning state of the vehicle based on the operation of the vehicle rotation member by the driver, a behavior which the driver is not conscious is more conspicuous. When there is the turning state of the vehicle based on the operation of the vehicle turning member by the driver, the width of the dead zone is adjusted to be larger than when there is no turning state based on the operation of the vehicle turning member by the driver. Therefore, it is possible to more suitably achieve the reduction of a sense of discomfort imposed on the driver and to suppress a vehicle behavior not intended by the driver.

The range of the dead zone may be adjusted in accordance with a turning direction in the turning state.

The vehicle operation member which shows a behavior which the driver is not conscious when being operated by the driver may change depending on the turning direction in the turning state. For this reason, the range of the dead zone is adjusted in accordance with the turning direction in the turning state. Therefore, it is possible to more suitably achieve the reduction of a sense of discomfort imposed on the driver and to suppress a vehicle behavior not intended by the driver.

The vehicle operation member may include an accelerator pedal which is provided on one side of the right side and the left side of the vehicle and a brake pedal which is provided on another side of the right side and the left side, and the width of the dead zone may increase with respect to a dead zone with a control amount based on an operation of the accelerator pedal or brake pedal disposed on a side corresponding to the turning direction in the turning state.

When the vehicle is in the turning state, a behavior which the driver is not conscious when a pedal disposed on a side corresponding to the turning direction is operated is more conspicuous. For this reason, the width of the dead zone increases with respect to a dead zone with a control amount based on the operation of the accelerator pedal or the brake pedal disposed on a side corresponding to the turning direction in the turning state. Therefore, it is possible to more suitably achieve the reduction of a sense of discomfort imposed on the driver and to suppress a vehicle behavior not intended by the driver.

The vehicle turning member may be operable in a different operation direction which is an operation direction other than an operation direction for the turning state of the vehicle, and the width of the dead zone may be adjusted on the basis of an operation in the different operation direction.

In this way, even when the width of the dead zone is adjusted on the basis of an operation in the different operation direction, it is possible to achieve the reduction of a sense of discomfort imposed on the driver and to suppress a vehicle behavior not intended by the driver.

### ADVANTAGEOUS EFFECTS OF INVENTION

According to the vehicle operation device of the invention, it is possible to reduce a sense of discomfort imposed on the driver when the driver carries out a driving operation and to suppress a vehicle behavior not intended by the driver.

### BRIEF DESCRIPTION OF DRAWINGS

FIG. 1 is a block configuration diagram of a vehicle operation device according to a first embodiment of the invention.

FIG. 2 is a flowchart showing a process procedure of the vehicle operation device according to the first embodiment.

FIG. 3 is a graph showing the relationship between a pedal reactive force and a vehicle output.

FIG. 4 is a perspective view of a steering of a vehicle operation device according to a second embodiment.

FIG. 5 is a table showing the relationship between the position in an axis contraction direction of a steering and the gear ratio of the steering.

FIG. 6 is a flowchart showing a process procedure of the vehicle operation device according to the second embodiment.

FIG. 7 is a table showing the relationship between the position in an axis contraction direction of a steering and a front wheel/rear wheel steering ratio.

### DESCRIPTION OF EMBODIMENTS

Hereinafter, embodiments of the invention will be described with reference to the accompanying drawings. In the description of the drawings, the same components are represented by the same reference numerals, and overlapping description will not be repeated. For convenience, dimensional proportions in the drawings may not coincide with those in the description.

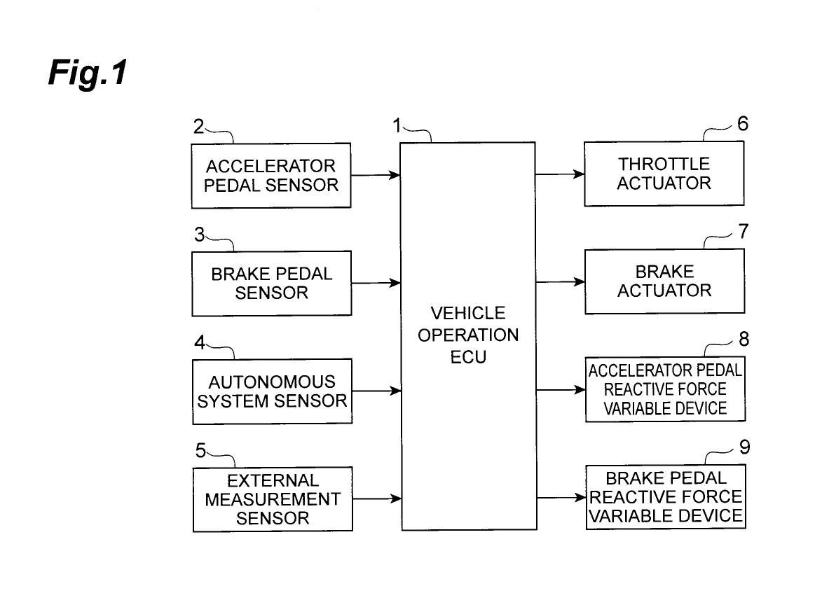

FIG. 1 is a block configuration diagram of a vehicle operation device according to a first embodiment of the invention. As shown in FIG. 1, the vehicle operation device of this embodiment includes a vehicle operation ECU 1. The vehicle operation ECU 1 is constituted by a CPU (Central Processing Unit) which performs an arithmetic process, a ROM (Read Only Memory) and a RAM (Random Access Memory) which serve as a storage unit, an input signal circuit, an output signal circuit, a power supply circuit, and the like.

An accelerator pedal sensor 2, a brake pedal sensor 3, an autonomous system sensor 4, and an external measurement sensor 5 are connected to the vehicle operation ECU 1. A throttle actuator 6, a brake actuator 7, an accelerator pedal reactive force variable device 8, and a brake pedal reactive force variable device 9 are connected to the vehicle operation ECU 1.

The accelerator pedal sensor 2 is connected to an accelerator pedal which is provided in the vehicle interior. The accelerator pedal is a foot-pedal which is disposed on the right side when viewed from the driver such that the driver primarily operates the pedal with his/her right foot. The accelerator pedal sensor 2 detects an accelerator pedal operation amount which is the accelerator pedal pressing amount of the accelerator pedal by the driver. The accelerator pedal sensor 2 transmits the detected accelerator pedal operation amount to the vehicle operation ECU 1.

The brake pedal sensor 3 is connected to a brake pedal which is provided in the vehicle interior. The brake pedal is a foot-pedal which is disposed on the left side when viewed from the driver such that the driver primarily operates the pedal with his/her left foot. The brake pedal sensor 3 detects a brake pedal operation amount which is the brake pedal pressing amount of the brake pedal by the driver. The brake pedal sensor 3 transmits the detected brake pedal operation amount to the vehicle operation ECU 1.

The autonomous system sensor 4 includes a front/rear/left/right acceleration sensor, a steering sensor, a vehicle speed sensor, and the like. A steering attached with a steering sensor is operable in a rotation direction (turning operation direction), and when the steering is operated in the turning operation direction, the vehicle is induced in the turning direction. The autonomous system sensor 4 acquires a vehicle state, such as the steering angle of the steering and the traveling speed or traveling direction of the vehicle, using these sensors. The autonomous system sensor 4 transmits a vehicle information signal including an acceleration signal according to a front/rear/left/right acceleration detected by the front/rear/left/right acceleration, a steering angle signal according to a steering angle detected by the steering sensor, a vehicle speed signal according to a vehicle speed detected by the vehicle speed sensor, and the like to the vehicle operation ECU 1.

The external measurement sensor 5 includes a camera, a radar, and the like which is attached on the front side of the vehicle. The camera captures an image in front of the vehicle and performs an image process on the captured image to acquire obstacle information, such as obstacles around the host vehicle. The radar is a laser radar, a millimeter-wave radar, or the like, measures the distance between an obstacle around the host vehicle and the host vehicle, and acquires the distance as distance information. The external measurement sensor 5 transmits the acquired obstacle information, distance information, and the like to the vehicle operation ECU 1.

The vehicle operation ECU 1 calculates a throttle actuator operation amount, which is an operation amount of the throttle actuator 6, on the basis of the accelerator pedal pressing amount transmitted from the accelerator pedal sensor 2. The vehicle operation ECU 1 transmits the calculated throttle actuator operation amount to the throttle actuator 6.

The vehicle operation ECU 1 calculates a brake actuator operation amount, which is an operation amount of the brake actuator 7, on the basis of the brake pedal pressing amount transmitted from the brake pedal sensor 3. The vehicle operation ECU 1 transmits the calculated brake actuator operation amount to the brake actuator 7.

The vehicle operation ECU 1 adjusts an accelerator pedal reactive force in the accelerator pedal reactive force variable device 8, and transmits an accelerator pedal reactive force variable signal to the accelerator pedal reactive force variable device 8. The vehicle operation ECU 1 adjusts a brake pedal reactive force in the brake pedal reactive force variable device 9, and transmits a brake pedal reactive force variable signal to the brake pedal reactive force variable device 9.

The vehicle operation ECU 1 adjusts the range of a dead zone in the accelerator pedal or the brake pedal on the basis of the steering angle signal in the vehicle information signal transmitted from the autonomous system sensor 4. The vehicle operation ECU 1 adjusts a reactive force in the accelerator pedal reactive force variable device 8 or the brake pedal reactive force variable device 9 in accordance with the adjusted range of the dead zone in the accelerator pedal or the brake pedal. The vehicle operation ECU 1 transmits an accelerator pedal reactive force variable signal according to the accelerator pedal reactive force after adjustment to the accelerator pedal reactive force variable device 8. The vehicle operation ECU 1 transmits a brake pedal reactive force variable signal according to the brake pedal reactive force after adjustment to the brake pedal reactive force variable device 9.

The throttle actuator 6 is an actuator which adjusts the throttle opening of the vehicle. The throttle actuator 6 adjusts the throttle opening of the vehicle on the basis of the throttle actuator operation amount transmitted from the vehicle operation ECU 1. The brake actuator 7 is an actuator which adjusts the brake amount of the vehicle. The brake actuator 7 adjusts the brake amount of the vehicle on the basis of the brake actuator operation amount transmitted from the vehicle operation ECU 1.

The accelerator pedal reactive force variable device 8 is attached to the accelerator pedal. The accelerator pedal reactive force variable device 8 adjusts the accelerator pedal reactive force on the basis of the accelerator pedal reactive force variable signal transmitted from the vehicle operation ECU 1. The brake pedal reactive force variable device 9 is attached to the brake pedal. The brake pedal reactive force variable device 9 adjusts the brake pedal reactive force on the basis of the brake pedal reactive force variable signal transmitted from the vehicle operation ECU 1.

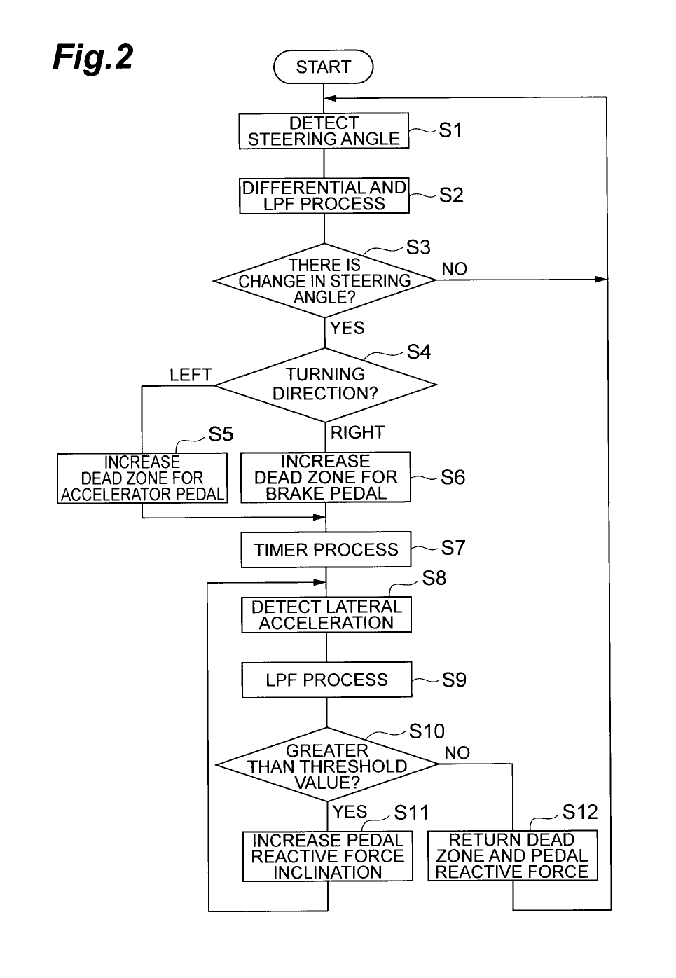

Next, the operation of the vehicle operation device of this embodiment will be described. FIG. 2 is a flowchart showing a process procedure of the vehicle operation device.

As shown in FIG. 2, in the vehicle operation device of this embodiment, first, the steering angle (turning angle) of the steering is detected by the autonomous system sensor 4 (S1). The autonomous system sensor 4 transmits a steering angle signal based on the detected steering angle to the vehicle operation ECU 1. Next, a differential process and a low-pass filter (LPF) process are performed on the steering angle signal transmitted from the autonomous system sensor 4 (S2). Subsequently, it is determined whether or not there is a change in the steering angle on the basis of the signal subjected to the differential process and the low-pass filter process (S3).

As a result, when there is no change in the steering angle, the process returns to Step S1, and the above-described operation is repeated. When there is a change in the steering angle, it is determined whether a turning direction by the turning operation of the steering is a right direction or a left direction (S4). When the turning direction of the steering is left, the dead zone of the accelerator pedal is increased (S5). When the turning direction of the steering is the right direction, the dead zone of the brake pedal is increased (S6).

If the steering is operated to the right or left, the driver tends to unconsciously strain his/her foot on a turning outer wheel side as a fulcrum. Accordingly, in a state where the steering is turned, the driver is likely to unconsciously strain his/her foot.

In particular, in a vehicle in which an accelerator pedal is provided on the right, and a brake pedal is provided on the left, if the accelerator pedal is operated when the steering is turned to the left, the acceleration of the vehicle tends to be higher than that intended by the the driver. To the contrary, if the brake pedal is operated when the steering is turned to the right, the deceleration of the vehicle tends to be lower than that intended by the driver.

When the driver is turning the steering, the dead zone of the accelerator pedal or the brake pedal increases. For this reason, a minimum requisite pressing force for displacing a pedal from a current pedal position increases, thereby improving stability of the vehicle.

In particular, when the turning direction of the steering is left, the dead zone of the accelerator pedal disposed on the right side, that is, on the turning outer wheel side of the vehicle is adjusted to be increased. For this reason, in a state where the operation amount of the accelerator pedal is likely to be increase, the dead zone of the accelerator pedal is increased, thereby preventing the vehicle from excessively increasing in speed. As a result, it is possible to increase traveling stability of the vehicle.

When the turning direction of the steering is right, the dead zone of the brake pedal disposed on the left side, that is, the turning outer wheel side of the vehicle is adjusted to be increased. For this reason, in a state where the operation amount of the brake pedal is likely to increase, the dead zone of the brake pedal is increased, thereby preventing the vehicle from excessively decreasing in speed. As a result, it is possible to increase traveling stability of the vehicle.

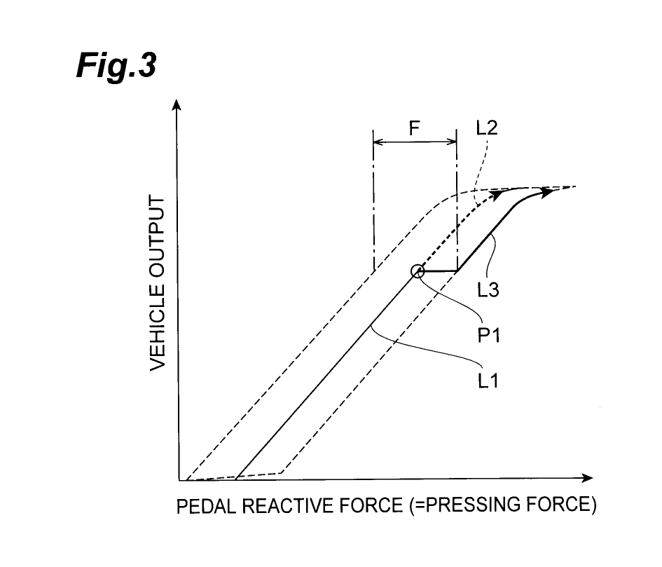

When increasing the dead zone of the accelerator pedal or the brake pedal, the vehicle output is shifted by the increased amount of the dead zone. For example, as shown in FIG. 3, it is assumed that the vehicle output, that is, a throttle actuator control amount or a brake actuator control amount is set as indicated by a solid line L1 with respect to a pedal reactive force (=pedal pressing force), that is, a reactive force in the accelerator pedal or the brake pedal.

When there is no steering operation during a pedal operation, the vehicle output is displaced along the solid line L1 and a bold broken line L2. Meanwhile, for example, it is assumed that a steering operation is carried out at a switching position P1. In this case, a dead zone F of the vehicle output is increased, and the vehicle output is displaced along a bold solid line L3 from the solid line L1.

If a steering operation is carried out, the vehicle output is shifted from the bold broken line L2 to the bold solid line L3. At this time, the bold broken line L2 and the bold solid line L3 substantially have the same output inclination. In this way, the dead zone is increased depending on the presence/absence of the steering operation to shift the vehicle output, thereby making it difficult for the vehicle output to be changed and setting the control amount depending on the accelerator pedal or the brake pedal. Therefore, it is possible to perform control in which an operation intention of the vehicle operation member by the driver is suitably reflected.

After the dead zone is increased in the above-described manner, a predetermined time is measured by a timer (S7). After the predetermined time has elapsed, the lateral acceleration of the vehicle is detected on the basis of an acceleration signal included in a vehicle information signal transmitted from the autonomous system sensor 4 (S8). Then, a low-pass filter process is performed on the detected lateral acceleration (S9), and it is determined whether or not the lateral acceleration is greater than a predetermined threshold value on the basis of the signal subjected to the low-pass filter process (S10).

As a result, when it is determined that the lateral acceleration is greater than the predetermined threshold value, the pedal reactive force inclinations of both the accelerator pedal and the brake pedal are increased (S11), and the process returns to Step S8. When it is determined that the lateral acceleration is not greater than the predetermined threshold value, the dead zone whose range has been increased in Step S5 or Step S6 and the pedal reactive force which has been increased in Step S11 are restored and return to the original states (S12). Thereafter, the process returns to Step S1, and the same operation is repeated.

As described above, in the vehicle operation device of this embodiment, the width of the dead zone is adjusted in accordance with the turning angle (turning direction) of the steering. For this reason, it is possible to reduce a sense of discomfort imposed on the driver when the driver carries out a driving operation and to suppress a vehicle behavior not intended by the driver.

The dead zone of the vehicle output when the accelerator pedal or the brake pedal is operated is adjusted. For this reason, it is possible to suitably suppress a behavior different from the intention of the driver. When the driver carries out a steering operation, the width of the dead zone of the vehicle output increases. Therefore, it is possible to more suitably achieve the reduction of a sense of discomfort imposed on the driver and to suppress a vehicle behavior not intended by the driver.

Next, a second embodiment of the invention will be described. A vehicle operation device of this embodiment is primarily different from the first embodiment in that the steering is operable in a direction (different operation direction) other than a turning operation direction, specifically, in an axial direction and there is a difference in control depending on a difference in the operation direction of the steering.

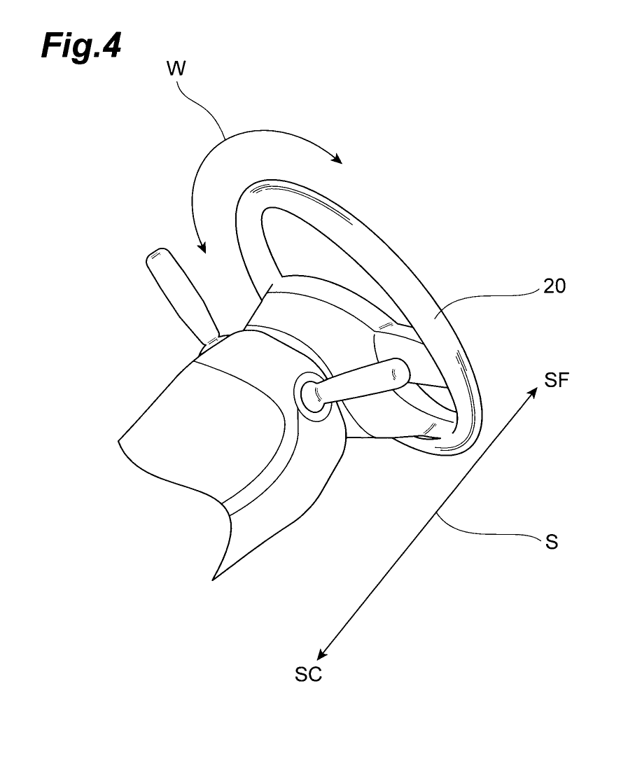

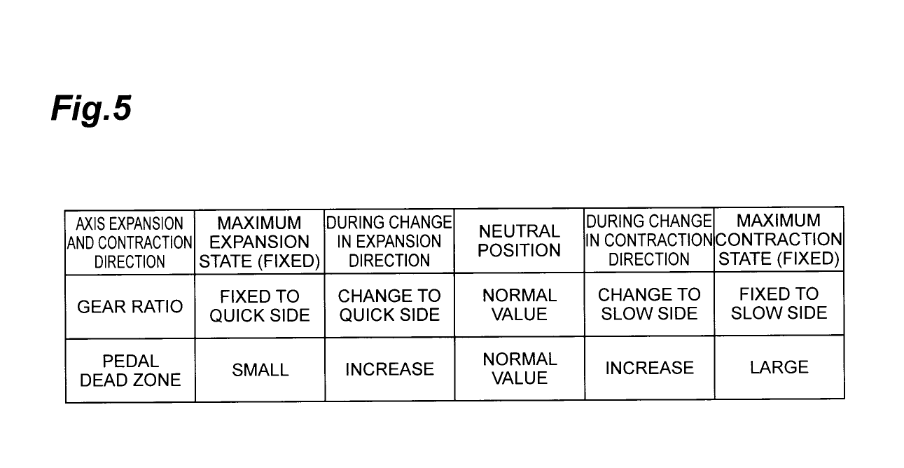

In the vehicle operation device of this embodiment, as shown in FIG. 4, a steering 20 is operable in an axis expansion and contraction direction S including an axis expansion direction SF and an axis contraction direction SC, in addition to a turning operation direction W. The steering 20 is operated in the axis expansion and contraction direction S, such that the gear ratio of the steering can be adjusted. The relationship between an expansion and contraction form in the axis expansion and contraction direction S and a gear ratio is as shown in FIG. 5.

In a state where the steering 20 has expanded to the maximum in the axis expansion direction SF, the gear ratio is fixed to a quick side. When the steering 20 is changing in the axis expansion direction SF, the gear ratio is changing to the quick side. When the steering 20 is at a neutral position in the axis expansion and contraction direction S, the gear ratio has a normal value.

When the steering 20 is changing in the axis contraction direction SC, the gear ratio is changing to a slow side. In a state where the steering 20 has contracted to the maximum in the axis contraction direction SC, the gear ratio is fixed to the slow side.

The autonomous system sensor 4 detects the expansion and contraction state (hereinafter, simply referred to as “expansion and contraction state” in the axial direction, in addition to the steering angle of the steering 20, and transmits a vehicle information signal with an expansion and contraction signal based on the detected expansion and contraction state to the vehicle operation ECU 1. The vehicle operation ECU 1 adjusts the range of the dead zone in the accelerator pedal or the brake pedal on the basis of the expansion and contraction signal included in the vehicle information signal transmitted from the autonomous system sensor 4. Other points are the same as those in the foregoing first embodiment.

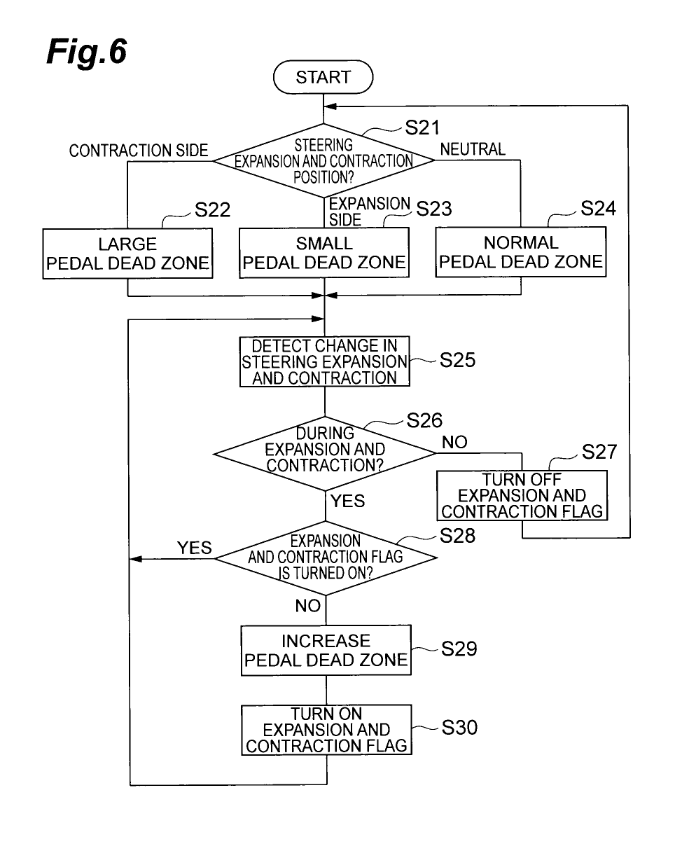

Next, the operation of the vehicle operation device of this embodiment will be described. FIG. 6 is a flowchart showing a process procedure of the vehicle operation device of this embodiment.

As shown in FIG. 6, in the vehicle operation device of the embodiment, the expansion and contraction position of the steering 20 is detected on the basis of an expansion and contraction signal included in a vehicle information signal transmitted from the autonomous system sensor 4 (S21). When it is determined that the expansion and contraction position is the maximum contraction position, the dead zones of the accelerator pedal and the brake pedal are set to be the maximum (S22). When it is determined that the expansion and contraction position is the maximum expansion position, the dead zones of the accelerator pedal and the brake pedal are set to be the minimum (S23). When it is determined that the expansion and contraction position is the neutral position, the dead zones are set to normal values (S24).

After the dead zones are set in the above-described manner, a change in the expansion and contraction direction of the steering is detected on the basis of the expansion and contraction signal included in the vehicle information signal transmitted from the autonomous system sensor 4 (S25). This detection performs a differential process and a low-pass filter process on the transmitted expansion and contraction signal. Subsequently, it is determined whether or not the steering 20 is expanding and contracting on the basis of the signal subjected to the differential process and the low-pass filter process (S26).

As a result, when it is determined that the steering 20 is not expanding and contracting, an expansion and contraction flag is turned off (S27), the process returns to Step S21, and the above-described operation is repeated. When it is determined that the steering 20 is expanding and contracting, it is determined whether or not the expansion and contraction flag is turned on (S28).

When the expansion and contraction flag is turned on, the process returns to Step S25, and the above-described operation is repeated. When the expansion and contraction flag is not turned on (is turned off), the dead zones of the accelerator pedal and the brake pedal are increased (S29). Thereafter, the expansion and contraction flag is turned on (S30), the process returns to Step S25, and the above-described operation is repeated.

As described above, in the vehicle operation device of this embodiment, the steering 20 is operable in the expansion and contraction direction. When the driver operates the steering 20 in the expansion and contraction direction, the range of the dead zone in each of the accelerator pedal and the brake pedal is adjusted on the basis of an operation in the expansion and contraction direction. For this reason, it is possible to achieve the reduction of a sense of discomfort imposed on the driver and to suppress a vehicle behavior not intended by the driver.

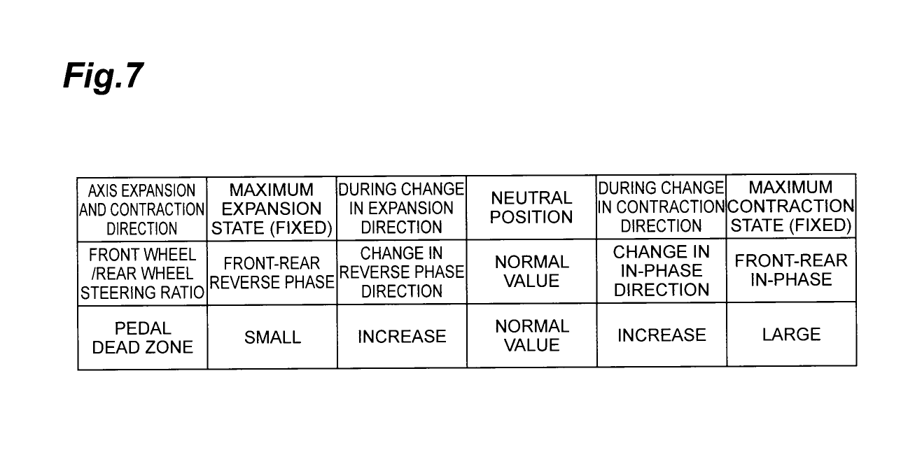

Although in the second embodiment, a mode has been described in which, when the steering is operated in the expansion and contraction direction, the gear ratio of the steering is adjusted, a mode may be used in which a steering ratio is adjusted between the front wheels and the rear wheels. For example, as shown in FIG. 7, in a state where the steering 20 has expanded to the maximum in the axis expansion direction SF, the front wheel/rear wheel steering ratio (hereinafter, referred to as “front-rear steering ratio”) is in a front-rear reverse phase. When the steering 20 is changing in the axis expansion direction SF, the front-rear steering ratio is changing in a reverse phase direction. When the steering 20 is at the neutral position in the axis expansion and contraction direction S, the front-rear steering ratio has a normal value.

When the steering 20 is changing in the axis contraction direction SC, the front-rear steering ratio is changing in an in-phase direction. In a state where the steering 20 has contracted to the maximum in the axis contraction direction SC, the front-rear steering ratio is fixed in phase.

At this time, with regard to the pedal dead zone, the same as in the foregoing second embodiment is applied. Specifically, in a state where the steering 20 has expanded to the maximum in the axis expansion direction SF, the pedal dead zone is minimized. When the steering 20 is changing in the axis expansion direction SF, the pedal dead zone is increased. When the steering 20 is at the neutral position in the axis expansion and contraction direction S, the pedal dead zone has the normal value. When the steering 20 is changing in the axis contraction direction SC, the pedal dead zone is increased. In a state where the steering 20 has contracted to the maximum in the axis contraction direction SC, the pedal dead zone is maximized. This mode may be used.

Although the preferred embodiments of the invention have been described, the invention is not limited to the foregoing embodiments. For example, although in the foregoing embodiments, the dead zone is adjusted on the basis of the vehicle state in the vehicle, the dead zone may be adjusted on the basis of the traveling environment of a traveling path along which the vehicle travels. For example, when a curve R in a traveling path along which the vehicle travels is large, the dead zone may be adjusted to be increased. At this time, it is preferable to increase the dead zone of a pedal disposed on the turning outer wheel side of the curve.

Although in the foregoing embodiments, the accelerator pedal and the brake pedal using foot-pedals are used as a vehicle operation member, other members may be used. For example, a joystick-type operation member, an operation button-type operation member, or the like which is operated by the driver with his/her hand may be used.

Although in the foregoing embodiments, the axial direction of the steering is exemplified as the different operation direction, oscillation of the shaft of the steering, an operation of a grip portion, and the like may be exemplified as other different operation directions.

### INDUSTRIAL APPLICABILITY

The invention can be used for a vehicle operation device.

### REFERENCE SIGNS LIST

1: vehicle operation ECU, 2: accelerator pedal sensor, 3: brake pedal sensor, 4: autonomous system sensor, 5: external measurement sensor, 6: throttle actuator, 7: brake actuator, 8:

accelerator pedal reactive force variable device, 9: brake pedal reactive force variable device, 20: steering.

1: A vehicle operation device comprising:
a vehicle operation member which is operable by a driver; and
a vehicle controller which performs control based on an operation of the vehicle operation member,
wherein a dead zone where a control amount is suppressed is set in a control range by the vehicle controller, and the range of the dead zone is adjusted on the basis of at least one of a vehicle state in a vehicle and the traveling environment of a traveling path along which the vehicle travels.

2: The vehicle operation device according to claim 1,
wherein a control amount by the vehicle controller is shifted in accordance with an adjustment amount of the dead zone.

3: The vehicle operation device according to claim 1,
wherein the vehicle operation member is at least one of an accelerator pedal and a brake pedal.

4: The vehicle operation device according to claim 1,
wherein the vehicle state is a turning state of the vehicle based on an operation of a vehicle turning member by the driver, and
when there is the turning state based on the operation of the vehicle turning member by the driver, the width of the dead zone is adjusted to be larger than when there is no turning state based on the operation of the vehicle turning member by the driver.

5: The vehicle operation device according to claim 4,
wherein the range of the dead zone is adjusted in accordance with a turning direction in the turning state.

6: The vehicle operation device according to claim 5,
wherein the vehicle operation member includes an accelerator pedal which is provided on one side of the right side and the left side of the vehicle and a brake pedal which is provided on another side of the right side and the left side, and
the width of the dead zone increases with respect to a dead zone with a control amount based on an operation of the accelerator pedal or brake pedal disposed on a side corresponding to the turning direction in the turning state.

7: The vehicle operation device according to claim 6,
wherein the vehicle turning member is operable in a different operation direction which is an operation direction other than an operation direction for the turning state of the vehicle, and
the width of the dead zone is adjusted on the basis of an operation in the different operation direction.
